(19) United States
(12) Patent Application Publication
(10) Pub. No.: US 2014/0074752 A1
(43) Pub. Date: Mar. 13, 2014

(54) Commerce System and Method of Providing Access to an Investment Signal Based on Product Information

(71) Applicant: Kenneth J. Ouimet, Davis, CA (US)

(72) Inventor: Kenneth J. Ouimet, Davis, CA (US)

(21) Appl. No.: 13/610,480

(22) Filed: Sep. 11, 2012

(51) Int. Cl. G06Q 40/06

(52) U.S. Cl. 705/36 R

(57) ABSTRACT

A commerce system has retailers offering products for sale to consumers. Product information associated with a plurality of products is collected. The product information includes a sale price for the products, an estimated cost to a retailer for the products and an estimated demand for the products. The product information is stored in a database. An investment signal is identified based on the product information. An investment signal alert is provided to notify investors about the investment signal. A future value of investing in the retailer is forecasted based on the investment signal. Future profitability of the retailer is estimated based on the investment signal. A value for the investment signal is estimated. A bid for access to the investment signal is accepted including an offer to share a portion of an investment trade. Investment decisions within the commerce system are controlled by providing access to the investment signal.

### FIELD OF THE INVENTION

The present invention relates in general to consumer purchasing and, more particularly, to a commerce system and method of providing access to an investment signal based on product information.

### BACKGROUND OF THE INVENTION

Economic and financial modeling and planning is commonly used to estimate or predict the performance and outcome of real systems, given specific sets of input data of interest. An economic-based system will have many variables and influences which determine its behavior. A model is a mathematical expression or representation, which predicts the outcome or behavior of the system under a variety of conditions. In one sense, it is relatively easy to review historical data, understand its past performance, and state with relative certainty that past behavior of the system was indeed driven by the historical data. A more difficult task is to generate a mathematical model of the system, which predicts how the system will behave with different sets of data and assumptions.

In its basic form, the economic model can be viewed as a predicted or anticipated outcome of a system defined by a mathematical expression and driven by a given set of input data and assumptions. The mathematical expression is formulated or derived from principles of probability and statistics, often by analyzing historical data and corresponding known outcomes, to achieve a best fit of the expected behavior of the system to other sets of data. In other words, the model should be able to predict the outcome or response of the system to a specific set of data being considered or proposed, within a level of confidence, or an acceptable level of uncertainty.

Economic modeling has many uses and applications. One area in which modeling has been applied is in the retail environment. Grocery stores, general merchandise stores, specialty shops, and other retail outlets face stiff competition for limited consumers and business. In the face of mounting competition and high expectations from investors, retailers must look for every advantage the retailers can muster in maximizing market share, sales, revenue, and profit. Economic modeling can be an effective tool in helping store owners and managers forecast and optimize business decisions. The retailer operates under a business plan to set pricing, order inventory, formulate and run promotions, add and remove product lines, organize product shelving and displays, select signage, hire employees, expand stores, collect and maintain historical sales data, evaluate performance and trends, and make strategic decisions. Based on economic modeling, the retailer can change the business plan as needed.

During the lifetime of a company, the company may solicit investments from investors in order to monetize previous investments from earlier investors or the founders of the company. A company may also wish to obtain more liquid capital for paying off debts or expanding the company. Before investing in a company, however, investors must be able to predict the level of risk and likely return on the investment. Investors want to know whether the company is healthy and growing, or whether the company is on the decline. In particular, investors want to know whether the company is profitable in the short-term, and whether the company will remain profitable over the medium- and long-term. Thus, the profitability of a company is relevant not only to the company itself, but also to potential investors who wish to gauge the level of risk for investing in a particular company.

One way investors can gauge the risk of a particular investment in a particular company is to review profits and losses of the company over time and use the data to forecast future profitability. Unfortunately, for investors, obtaining accurate and current financial information about a potential investment can be difficult. For example, publicly-traded companies may only provide financial statements a few times each year, such as once every quarter. Without up-to-date and accurate data about the health of a company, investors' predictions about the risk and potential return on an investment will be less accurate.

The accuracy of investors' predictions is decreased even further when companies intentionally misrepresent financial stability. For example, a common tactic for a company anticipating being acquired by investors, is to artificially inflate the perceived profitability of the company. In the retail context, a retailer may choose to raise prices for products above the prevailing prices in the market. In the short-term, when a consumer visits the retailer to purchase products, the consumer may be alarmed by the higher prices but will still likely choose to purchase the retailer's products. After all, the consumer is already at the store, and it would be inconvenient to travel to a competitor retailer outlet just to save money on the current shopping trip. But, the consumer may decide to patronize a different retailer with lower prices going forward. Because most consumers will still purchase the same volume of products from the retailer in the short-term, only at higher prices, the retailer successfully inflates short-term profits. In the medium- or long-terms, however, raising prices on products may significantly harm profitability because consumers are driven to patronize to competing retailers. Meanwhile, investors see increased short-term profits, are totally unaware of the retailer's behavior with respect to medium- and long-term profits, and may over estimate the value of investing in the retailer.

### SUMMARY OF THE INVENTION

A need exists for retailers to provide accurate and current data to investors relevant to an analysis of the risk and likely return on investments in companies. Accordingly, in one embodiment, the present invention is a method of controlling a commerce system comprising the steps of collecting product information associated with a plurality of products, storing the product information in a database, identifying an investment signal based on the product information, providing an investment signal alert to notify investors about the investment signal, and controlling investment decisions within the commerce system by providing access to the investment signal.

In another embodiment, the present invention is a method of controlling a commerce system comprising the steps of collecting product information associated with a plurality of products, storing the product information in a database, identifying an investment signal based on the product information, and providing access to the investment signal.

In another embodiment, the present invention is a method of controlling a commerce system comprising the steps of collecting product information associated with a plurality of products, identifying an investment signal based on the product information, and providing access to the investment signal.

In another embodiment, the present invention is a computer program product usable with a programmable computer processor having a computer readable program code embodied in a non-transitory computer usable medium for controlling a commerce system comprising the steps of collecting product information associated with a plurality of products, identifying an investment signal based on the product information, and providing access to the investment signal.

### BRIEF DESCRIPTION OF THE DRAWINGS

FIG. 1 illustrates a retailer engaged in commercial activity with a consumer;

FIG. 2 illustrates a commercial system with a manufacturer, distributor, retailer, and consumer;

FIG. 3 illustrates commercial transactions between consumers and retailers with the aid of a retailer service provider;

FIG. 4 illustrates an electronic communication network between members of the commerce system;

FIG. 5 illustrates a computer system operating with the electronic communication network;

FIG. 6 illustrates a consumer profile registration webpage with the retailer service provider;

FIG. 7 illustrates a consumer login webpage for the retailer service provider;

FIG. 8 illustrates a webpage with preference levels for product attributes defined by the consumer and entered into a personal assistant engine;

FIG. 9 illustrates commercial interaction between the consumers, retailers, and retailer service provider to generate a shopping list with discount offers;

FIG. 10 illustrates collecting product information from retailer websites directly by the retailer service provider or indirectly using consumer computers;

FIG. 11 illustrates a curve of price versus demand;

FIGS. 12a-12c illustrate a process of collecting product information from a retailer;

FIGS. 13a-13b illustrate a process for detecting an investment signal and providing access to the investment signal;

FIG. 14 illustrates collecting product information from a plurality of retailers and providing an investment signal alert to investors;

FIG. 15 illustrates an investment signal;

FIG. 16 illustrates detecting an investment signal based on product information;

FIGS. 17a-17b illustrate a process of collecting product information and identifying an investment signal based on the product information;

FIGS. 18a-18b illustrate collecting bids from investors for an investment signal and providing access to an investment signal to an investor; and

FIG. 19 illustrates a process of controlling the commerce system by providing access to an investment signal.

### DETAILED DESCRIPTION OF THE DRAWINGS

The present invention is described in one or more embodiments in the following description with reference to the figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

In the face of mounting competition and high expectations from investors, a business must look for every advantage it can muster in maximizing market share and profits. The ability to consider factors which materially affect overall revenue and profitability and adjust the business plan accordingly is vital to the success of the bottom line, and the fundamental need to not only survive but to prosper and grow.

Economic and financial modeling and planning are important business tools that allow companies to conduct business planning, forecast demand, and optimize prices and promotions to meet profit and/or revenue goals. Economic modeling is applicable to many businesses, such as manufacturing, distribution, wholesale, retail, medicine, chemicals, financial markets, investing, exchange rates, inflation rates, pricing of options, value of risk, research and development, and the like.

In the face of mounting competition and high expectations from investors, most, if not all, businesses must look for every advantage the retailers can muster in maximizing market share and profits. The ability to forecast demand, in view of pricing and promotional alternatives, and to consider other factors which materially affect overall revenue and profitability is vital to the success of the bottom line, and the fundamental need to not only survive but to prosper and grow.

In particular, economic modeling is essential to businesses that face thin profit margins, such as general consumer merchandisers and other retail outlets. Many businesses are interested in economic modeling and forecasting, particularly when the model provides a high degree of accuracy or confidence. Such information is a powerful tool and highly valuable to the business. While the present discussion will involve a retailer, it is understood that the system described herein is applicable to data analysis for other members in the chain of commerce, or other industries and businesses having similar goals, constraints, and needs.

Like businesses, investors also rely on financial and economic forecasts to reduce risk and maximize profits. Before investing in a company, sophisticated investors scrutinize the financial health of the company in order to reach a conclusion about the risk and potential return of investing in the company. For example, investors will typical analyze factors such as profits and losses over time, stability of income, tax issues, marketability of or demand for products or services, management, technological changes, and strength of competitors. Among the factors that investors consider, investors may be particularly interested in seeing sustained profits over a period of time, and will look for indications that past profits reflect future profitability. Generally speaking, investing in a company whose profits are stable or increasing is less risky than investing in a company whose profits are decreasing. In the case of the bond market, where investors essentially provide loans to private companies, a financial forecast indicating high profits in the future means that a bondholder is likely to be repaid. In the case of other types of investments, such as ownership of an equity stake in the company (e.g., stocks), the profitability of the company will directly influence the value of the equity stake.

Thus, understanding the financial position of a company prior to making investment decisions about the company is critical to making an accurate estimate of the risk of a potential investment. Unfortunately, obtaining accurate, detailed, and up-to-date information about the financial health and stability of a company can be difficult, particularly for outside investors. For example, publicly traded companies are only required to provide periodic reports (e.g., every quarter) that detail the financial performance of the company. Privately held companies typically have no legal obligation to provide much if any financial information to the public.

In addition, companies seeking investors may behave in a way that disguises or distorts the companies' true financial picture. For example, the owners or managers of company seeking to be acquired by investors or another company have a financial incentive to appear as financially stable as possible before being acquired in order to ensure that the company is purchased for the highest possible value.

In the case of a retailer seeking to be purchased by investors, the current owners of the retailer have a financial incentive to demonstrate high profits that are increasing, in order to increase the investors' perceived value of the retailer. In a common tactic, in order to create the appearance of high and increasing profits, the current owners of the retailer increase the prices of products sold by the retailer just before a final sales price for the retailer is negotiated with the investors. When customers visit the retailer, the customers see the high prices, but for the sake of convenience, many consumers will still decide to purchase from the retailer. In the future, however, many of the consumers may vow to patronize competitor retailers. Thus, in the short term, the retailer's sales volume is relatively stable, but because of higher prices, profits increase. Investors see the increase in profits and over-value the retailer, without any knowledge that the actions of the current owners of the retailer may have significantly harmed medium- and long-term profitability by driving customers to competitors for future shopping trips. In order to minimize risk and maximize return, investors, therefore, benefit from having accurate financial information that has not been manipulated by those with an economic incentive to disguise the truth.

A retailer routinely collects T-LOG sales data for most if not all products in the normal course of business. Using the T-LOG data, the system generates a demand model for one or more products at one or more stores. The model is based upon the T-LOG data for that product and includes a plurality of parameters. The values of the parameters define the demand model and can be used for making predictions about the future sales activity for the product. For example, the model for each product can be used to predict future demand or sales of the product at that store in response to a proposed price, associated promotions or advertising, as well as impact from holidays and local seasonal variations. Promotion and advertising increase consumer awareness of the product.

An economic demand model analyzes historical retail T-LOG sales data to gain an understanding of retail demand as a function of factors such as price, promotion, time, consumer, seasonal trends, holidays, and other attributes of the transaction. The demand model can be used to forecast future demand by consumers as measured by unit sales. Unit sales are typically inversely related to price, i.e., the lower the price, the higher the sales. The quality of the demand model—and therefore the forecast quality—is directly affected by the quantity, composition, and accuracy of historical T-LOG sales data provided to the model.

The retailer makes business decisions based on forecasts. The retailer orders stock for replenishment purposes and selects items for promotion or price discount. To support good decisions, it is important to quantify the quality of each forecast. The retailer can then review any actions to be taken based on the accuracy of the forecasts on a case-by-case basis.

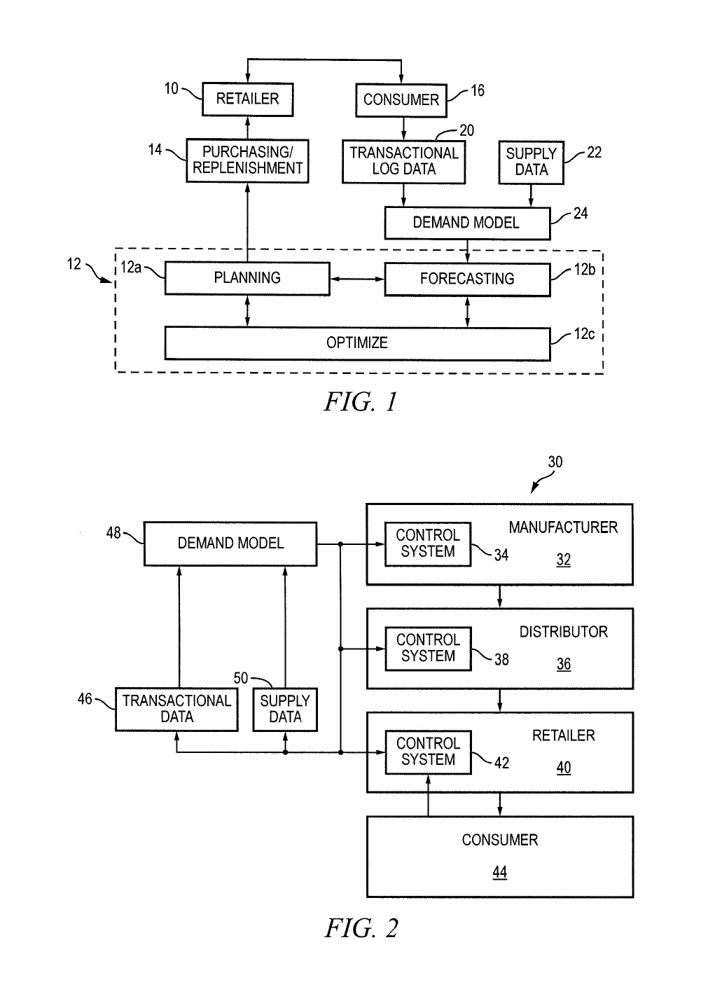

Referring to FIG. 1, retailer 10 has certain product lines or services available to consumers as part of its business plan 12. The terms products and services are interchangeable in the commercial system. Retailer 10 can be a food store chain, general consumer product retailer, drug store, discount warehouse, department store, apparel store, specialty store, or service provider. Retailer 10 has the ability to set pricing, order inventory, run promotions, arrange its product displays, collect and maintain historical sales data, and adjust its strategic business plan.

Business plan 12 includes planning 12a, forecasting 12b, and optimization 12c steps and operations. Business plan 12 gives retailer 10 the ability to evaluate performance and trends, make strategic decisions, set pricing, order inventory, formulate and run promotions, hire employees, expand stores, add and remove product lines, organize product shelving and displays, select signage, and the like. Business plan 12 allows retailer 10 to analyze data, evaluate alternatives, run forecasts, and make decisions to control its operations. With input from the planning 12a, forecasting 12b, and optimization 12c steps and operations of business plan 12, retailer 10 undertakes various purchasing or replenishment operations 14. Retailer 10 can change business plan 12 as needed.

Retailer 10 routinely enters into sales transactions with customer or consumer 16. In fact, retailer 10 maintains and updates its business plan 12 to increase the number of transactions (and thus revenue and/or profit) between retailer 10 and consumer 16. Consumer 16 can be a specific individual, account, or business entity.

For each sales transaction entered into between retailer 10 and consumer 16, information describing the transaction is stored in T-LOG 20. When a consumer goes through the check-out at a grocery or any other retail store, each of the items to be purchased is scanned and data is collected and stored by a point-of-sale (POS) system, or other suitable data collection and storage system, in T-LOG 20. The data includes the then current price, promotion, and merchandizing information associated with the product along with the units purchased, and the dollar sales. The date and time, and store and consumer information corresponding to that purchase are also recorded.

T-LOG data 20 contains one or more line items for each retail transaction, such as those shown in Table 1. Each line item includes information or attributes relating to the transaction, such as store number, product number, time of transaction, transaction number, quantity, current price, profit, promotion number, and consumer identity or type number. The store number identifies a specific store; product number identifies a product; time of transaction includes date and time of day; quantity is the number of units of the product; current price (in US dollars) can be the regular price, reduced price, or higher price in some circumstances; profit is the difference between current price and cost of selling the item; promotion number identifies any promotion associated with the product, e.g., flyer, ad, discounted offer, sale price, coupon, rebate, end-cap, etc.; consumer identifies the consumer by type, class, region, demographics, or individual, e.g., discount card holder, government sponsored or under-privileged, volume purchaser, corporate entity, preferred consumer, or special member. T-LOG data 20 is accurate, observable, and granular product information based on actual retail transactions within the store. T-LOG data 20 represents the known and observable results from the consumer buying decision or process. T-LOG data 20 may contain thousands of transactions for retailer 10 per store per day, or millions of transactions per chain of stores per day.

TABLE 1
T-LOG Data

| STORE | PRODUCT | TIME | TRANS | QTY | PRICE | PROFIT | PROMOTION | CONSUMER |
|---|---|---|---|---|---|---|---|---|
| S1 | P1 | D1 | T1 | 1 | 1.50 | 0.20 | PROMO1 | C1 |
| S1 | P2 | D1 | T1 | 2 | 0.60 | 0.05 | PROMO2 | C1 |
| S1 | P3 | D1 | T1 | 3 | 3.00 | 0.40 | PROMO3 | C1 |
| S1 | P4 | D1 | T2 | 4 | 1.60 | 0.50 | 0 | C2 |
| S1 | P5 | D1 | T2 | 1 | 2.25 | 0.60 | 0 | C2 |
| S1 | P6 | D1 | T3 | 10 | 2.65 | 0.55 | PROMO4 | C3 |
| S1 | P1 | D2 | T4 | 5 | 1.50 | 0.20 | PROMO1 | C4 |
| S2 | P7 | D3 | T5 | 1 | 5.00 | 1.10 | PROMO5 | C5 |
| S2 | P1 | D3 | T6 | 2 | 1.50 | 0.20 | PROMO1 | C6 |
| S2 | P8 | D3 | T6 | 1 | 3.30 | 0.65 | 0 | C6 |

The first line item shows that on day/time D1, store S1 has transaction T1 in which consumer C1 purchases one product P1at $1.50. The next two line items also refer to transaction T1 and day/time D1, in which consumer C1 also purchases two products P2 at $0.60 each and three products P3 at price $3.00 each. In transaction T2 on day/time D1, consumer C2 has four products P4 at price $1.60 each and one product P5 at price $2.25. In transaction T3 on day/time D1, consumer C3 has ten products P6 at $2.65 each in his or her basket. In transaction T4 on day/time D2 (different day and time) in store S1, consumer C4 purchases five products P1 at price $1.50 each. In store S2, transaction T5 with consumer C5 on day/time D3 (different day and time) involves one product P7 at price $5.00. In store S2, transaction T6 with consumer C6 on day/time D3 involves two products P1 at price $1.50 each and one product P8 at price $3.30.

Table 1 further shows that product P1 in transaction T1 has promotion PROMO1. PROMO1 can be any suitable product promotion such as a front-page featured item in a local advertising flyer. Product P2 in transaction T1 has promotion PROMO2 as an end-cap display in store S1. Product P3 in transaction T1 has promotion PROMO3 as a reduced sale price with a discounted offer. Product P4 in transaction T2 on day/time D1 has no promotional offering. Likewise, product P5 in transaction T2 has no promotional offering. Product P6 in transaction T3 on day/time D1 has promotion PROMO4 as a volume discount for 10 or more items. Product P7 in transaction T5 on day/time D3 has promotion PROMO5 as a $0.50 rebate. Product P8 in transaction T6 has no promotional offering. A promotion may also be classified as a combination of promotions, e.g., flyer with sale price, end-cap with rebate, or discounted offer as described below.

Retailer 10 may also provide additional information to T-LOG data 20 such as promotional calendar and events, holidays, seasonality, store set-up, shelf location, end-cap displays, flyers, and advertisements. The information associated with a flyer distribution, e.g., publication medium, run dates, distribution, product location within flyer, and advertised prices, is stored within T-LOG data 20.

Supply data 22 is also collected and recorded from manufacturers and distributors. Supply data 22 includes inventory or quantity of products available at each location in the chain of commerce, i.e., manufacturer, distributor, and retailer. Supply data 22 includes product on the store shelf and replenishment product in the retailer's storage area.

With T-LOG 20 and supply data 22 collected, various suitable methods or algorithms can be used to analyze the data and form demand model 24. Model 24 may use a combination of linear, nonlinear, deterministic, stochastic, static, or dynamic equations or models for analyzing T-LOG 20 or aggregated T-LOG data and supply data 22 and making predictions about consumer behavior to future transactions for a particular product at a particular store, or across entire product lines for all stores. Model 24 is defined by a plurality of parameters and can be used to generate unit sales forecasting, price optimization, promotion optimization, markdown/clearance optimization, assortment optimization, merchandize and assortment planning, seasonal and holiday variance, and replenishment optimization. Model 24 has a suitable output and reporting system that enables the output from model 24 to be retrieved and analyzed for updating business plan 12.

In FIG. 2, a commerce system 30 is shown involving the movement of goods between members of the system. Manufacturer 32 produces goods in commerce system 30. Manufacturer 32 uses control system 34 to receive orders, control manufacturing and inventory, and schedule deliveries. Distributor 36 receives goods from manufacturer 32 for distribution within commerce system 30. Distributor 36 uses control system 38 to receive orders, control inventory, and schedule deliveries. Retailer 40 receives goods from distributor 36 for sale within commerce system 30. Retailer 40 uses control system 42 to place orders, control inventory, and schedule deliveries with distributor 36. Retailer 40 sells goods to consumer 44. Consumer 44 patronizes retailer's establishment, either in person, or using online ordering. The consumer purchases are entered into control system 42 of retailer 40 as T-LOG data 46.

The purchasing decisions made by consumer 44 drive the manufacturing, distribution, and retail portions of commerce system 30. More purchasing decisions made by consumer 44 for retailer 40 lead to more merchandise movement for all members of commerce system 30. Manufacturer 32, distributor 36, and retailer 40 utilize demand model 48 (similar to model 24), via respective control systems 34, 38, and 42, to control and optimize the ordering, manufacturing, distribution, sale of the goods, and otherwise execute respective business plan 12 within commerce system 30 in accordance with the purchasing decisions made by consumer 44.

Manufacturer 32, distributor 36, and retailer 40 provide historical T-LOG 46 and supply data 50 to demand model 48 by electronic communication link, which in turn generates forecasts to predict the need for goods by each member and control its operations. In one embodiment, each member provides its own historical T-LOG data 46 and supply data 50 to demand model 48 to generate a forecast of demand specific to its business plan 12. Alternatively, all members can provide historical T-LOG data 46 and supply data 50 to demand model 48 to generate composite forecasts relevant to the overall flow of goods. For example, manufacturer 32 may consider a proposed discounted offer, rebate, promotion, seasonality, or other attribute for one or more goods that it produces. Demand model 48 generates the forecast of sales based on available supply and the proposed price, consumer, rebate, promotion, time, seasonality, or other attribute of the goods. The forecast is communicated to control system 34 by electronic communication link, which in turn controls the manufacturing process and delivery schedule of manufacturer 32 to send goods to distributor 36 based on the predicted demand ultimately determined by the consumer purchasing decisions. Likewise, distributor 36 or retailer 40 may consider a proposed discounted offer, rebate, promotion, or other attributes for one or more goods that it sells. Demand model 48 generates the forecast of demand based on the available supply and proposed price, consumer, rebate, promotion, time, seasonality, and/or other attribute of the goods. The forecast is communicated to control system 38 or control system 42 by electronic communication link, which in turn controls ordering, distribution, inventory, and delivery schedule for distributor 36 and retailer 40 to meet the predicted demand for goods in accordance with the forecast.

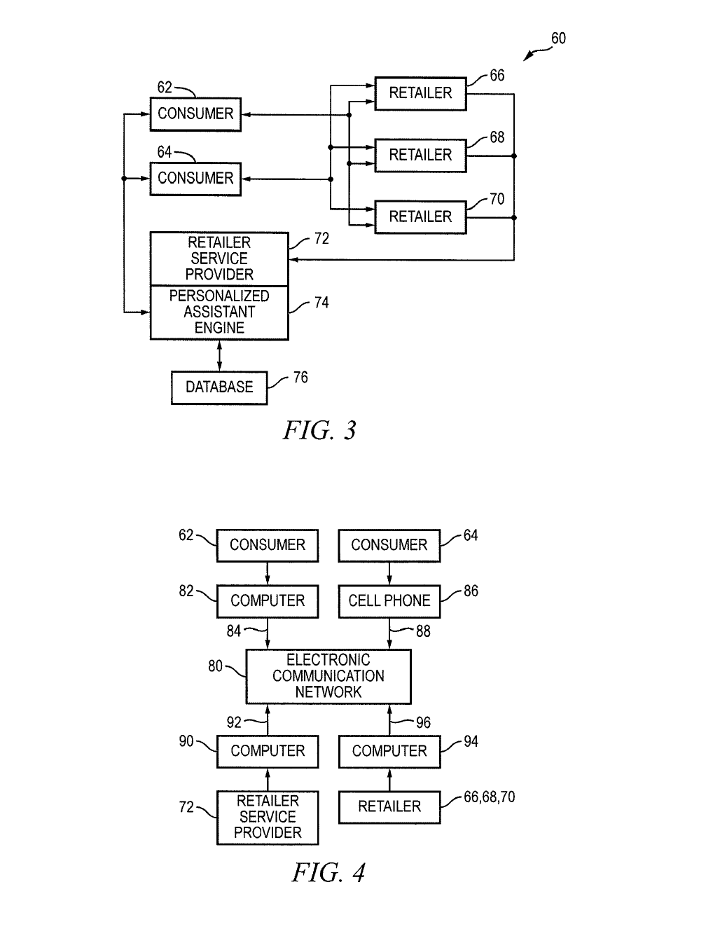

FIG. 3 illustrates a commerce system 60 with consumers 62 and 64 engaged in purchasing transactions with retailers 66, 68, and 70. Retailers 66-70 are supplied by manufacturers and distributors, as described in FIG. 2. Retailers 66-70 are typically local to consumers 62-64, i.e., retailers that the consumers will likely patronize. Retailers 66-70 can also be remote from consumers 62-64 with transactions handled by electronic communication medium, e.g., phone or online website via personal computer, and delivered electronically or by common carrier, depending on the nature of the goods. Consumers 62-64 patronize retailers 66-70 by selecting one or more items for purchase from one or more retailers. For example, consumer 62 can visit the store of retailer 66 in person and select product P1 for purchase. Consumer 62 can contact retailer 68 by phone or email and select product P2 for purchase. Consumer 64 can browse the website of retailer 70 using a personal computer and select product P3 for purchase. Accordingly, consumers 62-64 and retailers 66-70 regularly engage in commercial transactions within commerce system 60.

As described herein, manufacturer 32, distributor 36, retailers 66-70, consumers 62-64, and retailer service provider 72 are considered members of commerce system 60. The retailer generally refers to the seller of the product and consumer generally refers to the buyer of the product. Depending on the transaction within commerce system 60, manufacturer 32 can be the seller and distributor 36 can be the buyer, or distributor 36 can be the seller and retailers 66-70 can be the buyer, or manufacturer 32 can be the seller and consumers 62-64 can be the buyer.

A retailer service provider 72 is a part of commerce system 60. Retailer service provider 72 is a third party that assists consumers 62-64 with the product evaluation and purchasing decision process by providing access to a comparative shopping service. More specifically, retailer service provider 72 operates and maintains personal assistant engine 74 that prioritizes product attributes and optimizes product selection according to consumer-weighted preferences. The product attributes and consumer-weighted preferences are stored in database 76. In addition, personal assistant engine 74 generates a discounted offer for a product to entice a positive purchasing decision by a specific consumer. Personal assistant engine 74 saves the consumer considerable time and money by providing access to a comprehensive, reliable, and objective comparative shopping service.

Each consumer goes through a product evaluation and purchasing decision process each time a particular product is selected for purchase. Some product evaluations and purchasing decision processes are simple and routine. For example, when consumer 62 is conducting weekly shopping in the grocery store, the consumer considers a needed item or item of interest, e.g., canned soup. Consumer 62 may have a preferred brand, size, and flavor of canned soup. Consumer 62 selects the preferred brand, size, and flavor sometimes without consideration of price, places the item in the basket, and moves on. The product evaluation and purchasing decision process can be almost automatic and instantaneous but nonetheless still occurs based on prior experiences and preferences. Consumer 62 may pause during the product evaluation and purchasing decision process and consider other canned soup options. Consumer 62 may want to try a different flavor or another brand offering a lower price. As the price of the product increases, the product evaluation and purchasing decision process usually becomes more involved. If consumer 62 is shopping for a major appliance, the product evaluation and purchasing decision process may include consideration of several manufacturers, visits to multiple retailers, review of features and warranty, talking to salespersons, reading consumer reviews, and comparing prices. In any case, understanding the consumer's approach to the product evaluation and purchasing decision process is part of an effective comparative shopping service. The comparative shopping service assists the consumer in finding the optimal price and product attributes, e.g., brand, quality, quantity, size, features, ingredients, service, warranty, and convenience, that are important to the consumer and tip the purchasing decision toward selecting a particular product and retailer.

Personal assistant engine 74 can be made available to consumers 62-64 via computer-based online website or other electronic communication medium, e.g., wireless cell phone or other personal communication device. FIG. 4 shows an electronic communication network 80 for transmitting information between consumers 62-64, retailer service provider 72, and retailers 66-70. Consumer 62 operating with computer 82 is connected to electronic communication network 80 by way of communication channel or link 84. Likewise, consumer 64 operating with a cellular telephone, smart phone, or other wireless communication device 86, is connected to electronic communication network 80 by way of communication channel or link 88. Retailer service provider 72 uses computer 90 to communicate with electronic communication network 80 over communication channel or link 92. Retailers 66-70 use computer 94 to communicate with electronic communication network 80 over communication channel or link 96. The electronic communication network 80 is a distributed network of interconnected routers, gateways, switches, and servers, each with a unique internet protocol (IP) address to enable communication between individual computers, cellular telephones, electronic devices, or nodes within the network. In one embodiment, electronic communication network 80 is a cell phone service network. Alternatively, communication network 80 is a global, open-architecture network, commonly known as the Internet. Communication channels 84, 88, 92, and 96 are bi-directional and transmit data between computers 82, 90, and 94 and cell phone 86 and electronic communication network 80 in a hard-wired or wireless configuration. For example, computers 82, 90, and 94 have email, texting, and Internet capability, and consumer cell phone 86 has email, mobile applications (apps), texting, and Internet capability.

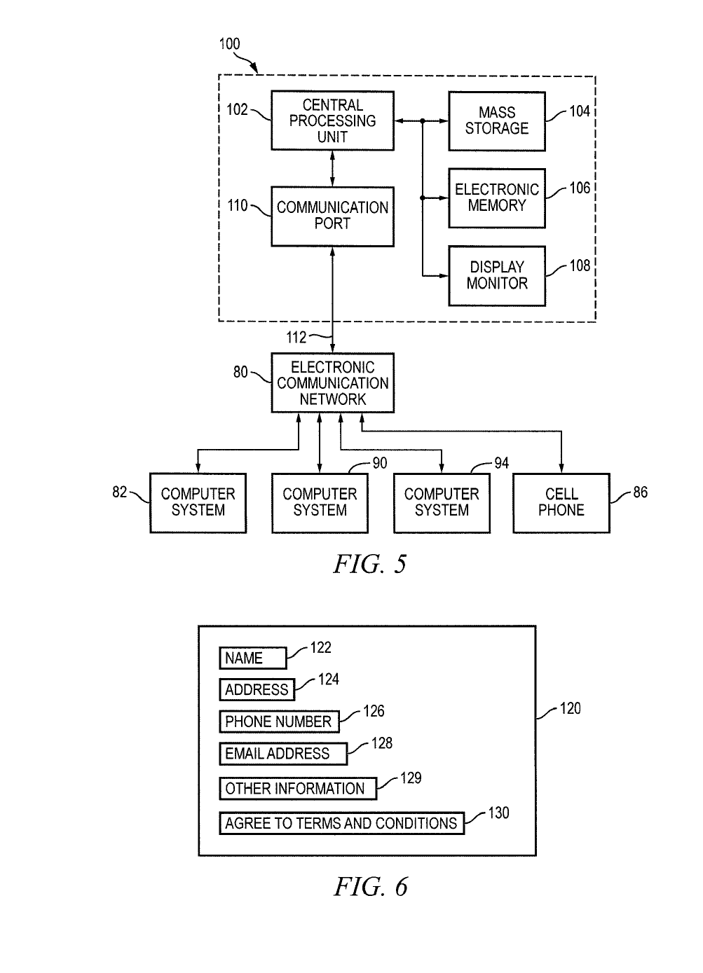

Further detail of the computer systems used in electronic communication network 80 is shown in FIG. 5 as a simplified computer system 100 for executing the software program used in the electronic communication process. Computer system 100 is a general purpose computer including a processing unit or microprocessor 102, mass storage device or hard disk 104, electronic memory 106, display monitor 108, and communication port 110. Communication port 110 represents a modem, high-speed Ethernet link, wireless, or other electronic connection to transmit and receive input/output (I/O) data over communication link 112 to electronic communication network 80. Computer system or server 82, 90, and 94 can be configured as shown for computer 100. Computer system 82, 90, 94, and 100 and cell phone 86 transmit and receive information and data over communication network 80.

Computer systems 82, 90, 94, and 100 can be physically located in any location with access to a modem or communication link to network 80. For example, computer 82, 90, 94, and 100 can be located in a home or business office. Retailer service provider 72 may use computer system 82, 90, 94, or 100 in its business office. Alternatively, computer 82, 90, 94, and 100 can be mobile and follow the user to any convenient location, e.g., remote offices, consumer locations, hotel rooms, residences, vehicles, public places, or other locales with electronic access to electronic communication network 80. The consumer can access electronic communication network 80 by mobile app operating in cell phone 86.

Each of the computers runs application software and computer programs, which can be used to display user interface screens, execute the functionality, and provide the electronic communication features as described below. The application software includes an Internet browser, local email application, mobile apps, word processor, spreadsheet, and the like. In one embodiment, the screens and functionality come from the application software, i.e., the electronic communication runs directly on computer system 82, 90, 94, and 100. Alternatively, the screens and functions are provided remotely from one or more websites on servers within electronic communication network 80.

The software is originally provided on computer readable media, such as compact disks (CDs), external drive, or other mass storage medium. Alternatively, the software is downloaded from electronic links, such as the host or vendor website. The software is installed onto the computer system hard drive 104 and/or electronic memory 106, and is accessed and controlled by the computer operating system. Software updates are also electronically available on mass storage medium or downloadable from the host or vendor website. The software, as provided on the computer readable media or downloaded from electronic links, represents a computer program product containing computer readable program code embodied in a computer program medium. Computers 82, 90, 94, and 100 run application software to execute instructions for communication between consumers 62 and 64 and retailer service provider 72 to perform the functions described herein. Cell phone 86 runs one or more mobile apps to execute instructions for communication between consumers 62 and 64 and retailer service provider 72. The application software is an integral part of the control of commercial activity within commerce system 60.

To interact with retailer service provider 72, consumers 62 and 64 first create an account and profile with the retailer service provider by electronic links 84 and 88. Consumers 62 and 64 can use some features offered by retailer service provider 72 without creating an account, but full access requires completion of a registration process. The consumer accesses website 120 operated by retailer service provider 72 on computer systems 82, 90, 94, or 100 and provides data to complete the registration and activation process, as shown in FIG. 6. The consumer can access website 120 using cell phone 86 or computer systems 82, 90, 94, or 100 by typing the uniform resource locator (URL) for website 120, or by clicking on a banner located on another website which re-directs the consumer to a predetermined landing page for website 120. The data provided by the consumer to retailer service provider 72 may include name in block 122, home address and work address with zip code in block 124, phone number in block 126, email address in block 128, and other information and credentials in block 129 necessary to establish a profile, identity, and general preferences for the consumer. The consumer's home and work address and zip code are important as shopping is often a local activity. The consumer agrees to the terms and conditions of conducting electronic communication through retailer service provider 72 in block 130.

The profile can also contain information related to the shopping habits and preferences of consumers 62-64. For example, the other information in block 129 includes product preferences, consumer characteristics, and consumer demographics, e.g., gender, age, family size, age of children, occupation, medical conditions, shopping budget, and general product preferences (low fat, high fiber, vegetarian, natural with no preservatives, biodegradable, convenience of preparation or use, name brand, generic brands, kosher). Consumers 62-64 can specify preferred retailers and spending patterns. Alternatively, retailers 66-70 can provide T-LOG data 46 to retailer service provider 72 to accurately track the shopping patterns of consumers 62-64. Consumer service provider 72 will have records of consumer loyalty and value to each retailer. Consumer value is based on spending patterns of the consumer.

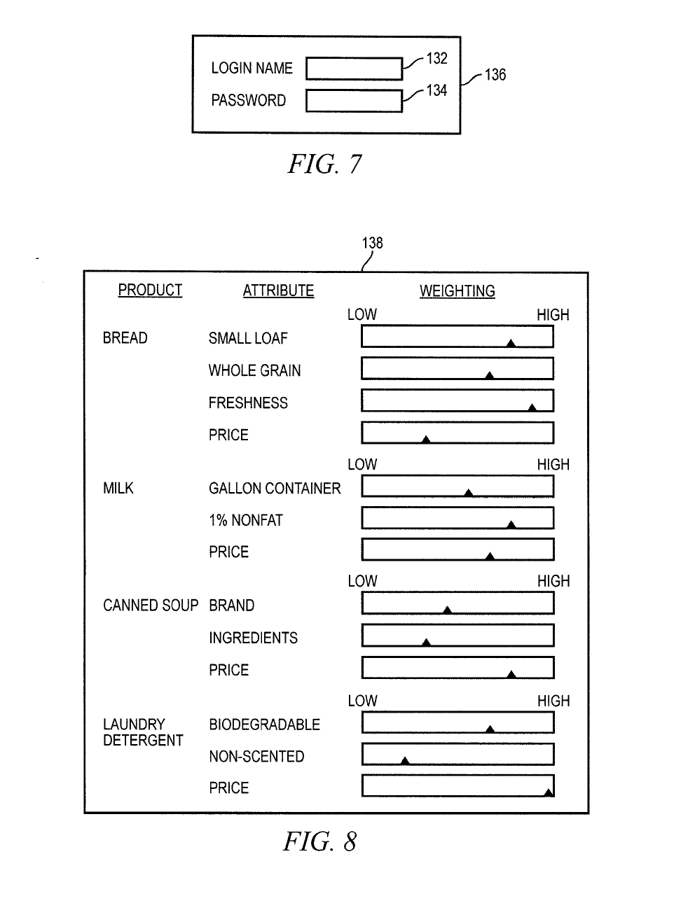

The consumer's profile is stored and maintained within database 76. The consumer can access and update his or her profile or interact by entering login name 132 and password 134 in webpage 136, as shown in FIG. 7. The consumer name can be any personal name, user name, number, or email address that uniquely identifies the consumer and the password can be assigned to or selected by the consumer. Accordingly, the consumer's profile and personal data remain secure and confidential within database 76 by retailer service provider 72.

Once logged-in to retailer service provider 72, consumers 62 and 64 utilize personal assistant engine 74 to assist with the shopping process. More specifically, consumers 62 and 64 provide commonly purchased products or anticipated purchase products through webpage 138, as shown in FIG. 8. Each product will have product attributes weighted by consumer preference. Webpage 138 can display a list of available product attributes associated with each product category. The available product attributes can be product-specific attributes, diet/health/nutrient related product attributes, lifestyle related product attributes, environment related product attributes, allergen related product attributes, and social/society related product attributes. The product-specific attributes can include brand, ingredients, size, price, freshness, warranty, and the like. The consumer defines the products, adds one or more product attributes, and assigns weighted preferences with a sliding scale from 0 (lowest importance) to 9 (highest importance). For example, the consumer may define the products of interest as bread, milk, canned soup, and laundry detergent. The consumer adds product attributes for each product and, using a sliding scale, assigns a preference level for each product attribute, as shown in webpage 138. The sliding scale adjusts the preference level of the product attribute by dragging a pointer along the length of the sliding scale. In the present example, the consumer preference levels for bread attributes are 7 for small loaf, 6 for whole grain, 8 for freshness, and 3 for price. The consumer preference levels for milk attributes are 5 for gallon container, 7 for 1% low fat, and 6 for price. The consumer preference levels for canned soup attributes are 4 for brand, 3 for product ingredients, and 7 for price. The consumer preference levels for laundry detergent attributes are 6 for biodegradable, 2 for non-scented, and 9 for price.

The consumer can also identify a specific preferred retailer as an attribute with an assigned preference level based on convenience and personal experience. The consumer may assign value to shopping with a specific retailer because of specific products offered by that store, familiarity with the store layout, good retailer service experiences, or location that is convenient on the way home from work, picking up the children from school, or routine weekend errand route.

Personal assistant engine 74 may also present consumers 62 or 64 with an website interface for browsing or searching for products among various local or online retailers. Personal assistant engine 74 stores the consumer-defined products and attributes from webpage 138 for future reference and updating. Personal assistant engine 74 can also store prices, product descriptions, names and locations of the retail stores selling the products, offer histories, purchase histories, as well as various rules, policies and algorithms in database 76.

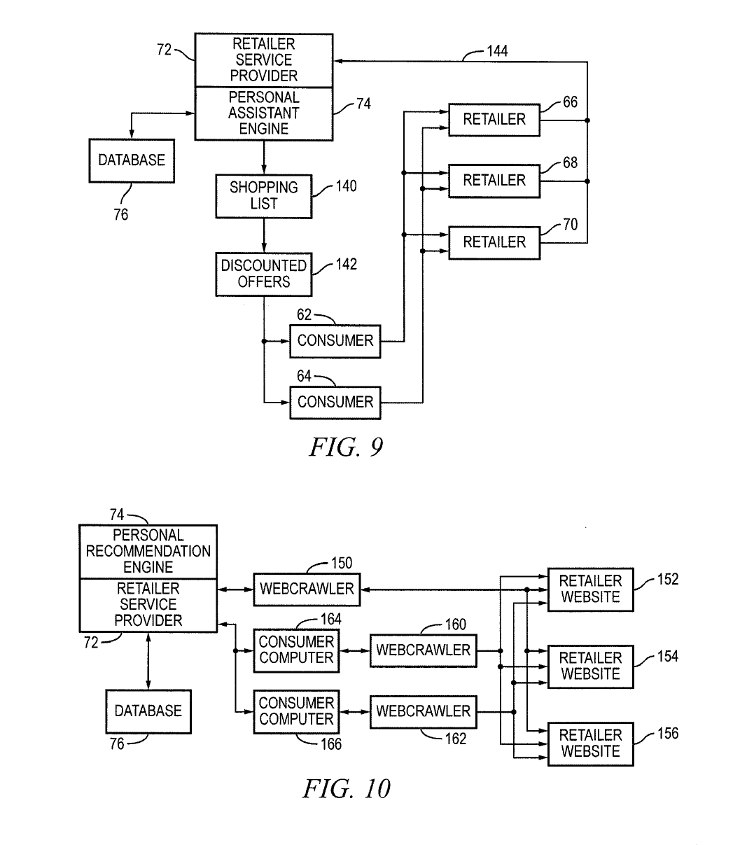

Personal assistant engine 74 generates shopping list 140 with weighted product attributes and individualized discounted offers 142 for each specific consumer upon request, as shown in FIG. 9. The individualized discounted offers 142 can include default discount offers and individualized discount offers. The individual products in shopping list 140 can be added or deleted and the weighted product attributes can be changed by the consumer. Shopping list 140 and discounted offers 142 are specific for each consumer and allow retailer service provider 72 to track specific products and preferred retailers selected by the consumer. Consumers 62 and 64 use shopping list 140 and discounted offers 142 to patronize retailers 66-70.

The consumer patronizes retailers 66-70, either in person or online, with shopping list 140 from personal assistant engine 74 in hand and makes purchasing decisions based on the recommendations on the shopping list. The consumers can rely on personal assistant engine 74 as having produced a comprehensive, reliable, and objective shopping list in view of the consumer's profile and weighted product preferences, as well as retailer product information, that will yield the optimal purchasing decision to the benefit of the consumer. In addition, the discounted price should be set to trigger the purchasing decision. Personal assistant engine 74 helps consumers quantify and develop confidence in making a good decision to purchase a particular product from a particular retailer. While the consumer makes the decision to place the product in the basket for purchase, he or she comes to rely upon, or at least consider, the recommendations from retailer service provider 72, i.e., shopping list 140 contributes to the tipping point for consumers to make the purchasing decision. The consumer model generated by personal assistant engine 74 thus in part controls many of the purchasing decisions and other aspects of commercial transactions within commerce system 60.

In order to store and maintain shopping list 140 for each consumer, personal assistant engine 74 must have access to up-to-date, comprehensive, reliable, and objective retailer product information. Retailer service provider 72 maintains database 76 with up-to-date, comprehensive, reliable, and objective retailer product information. The product information includes the product description, product attributes, regular retail pricing, and discounted offers. Retailer service provider 72 must actively and continuously gather up-to-date product information in order to maintain database 76.

In one approach to gathering product information, retailers 66-70 may grant access to T-LOG data 46 for use by retailer service provider 72 in return for retailer service provider 72 recommending specific products to consumers, or in return for being part of the network of retailers available to consumers using retailer service provider 72 as a shopping tool. T-LOG data 46 collected during consumer check-out can be sent electronically from retailers 66-70 to retailer service provider 72, as shown by communication link 144 in FIG. 9.

Retailers 66-70 may be reluctant to grant access to T-LOG data 46, particularly without quid pro quo. However, as retailer service provider 72 gains acceptance and consumers 62-64 come to rely on the service to make purchasing decisions, retailers 66-70 will be motivated to participate.

One or more retailers 66-70 may decline to provide access to its T-LOG data for use with personal assistant engine 74. In such cases, retailer service provider 72 can exercise a number of alternative data gathering approaches and sources. In one embodiment, retailer service provider 72 utilizes computer-based webcrawlers or other searching software to access retailer websites for pricing and other product information.

In FIG. 10, webcrawler 150 operates within the software of computer systems 82, 90, 94, or 100 used by retailer service provider 72. Retailer service provider 72 dispatches webcrawler 150 to make requests for product information from websites or portals 152, 154, and 156 of retailers 66, 68, and 70, respectively. Webcrawler 150 collects and returns the product information to personal assistant engine 74 for storage within database 76. For example, webcrawler 150 identifies products available from each of retailer websites 152-156 and requests pricing and other product information for each of the identified products. Webcrawler 150 navigates and parses each page of retailer websites 152-156 to locate pricing and other product information. The parsing operation involves identifying and recording product description, universal product code (UPC), price, ingredients, size, and other product information as recovered by webcrawler 150 from retailer websites 152-156. In particular, the parsing operation can identify discounted offers and special pricing from retailers 66-70. The product information from retailer websites 152-156 is sorted and stored in database 76.

Retailer service provider 72 can also dispatch webcrawlers 160 and 162 from computers 164 and 166 used by consumers 62-64, or from consumer cell phone 86, or other electronic communication device, to access and request product information from retailer websites or portals 152-156 or other electronic communication medium or access point. During the registration process of FIG. 6, retailer service provider 72 acquires the IP address of consumer computers 164 and 166, as well as the permission of the consumers to utilize the consumer computer and login to access retailer websites 152-156. Retailer service provider 72 causes webcrawlers 160-162 to be dispatched from consumer computers 164-166 and uses the consumer login to retailer websites 152-156 to access and request product information from retailers 66-70. Webcrawlers 160-162 collect the product information from retailer websites 152-156 through the consumer computer and login and return the product information to personal assistant engine 74 for storage within database 76. The execution of webcrawlers 160-162 from consumer computers 164-166 distributes the computational work.

For example, retailer service provider 72 initiates webcrawler 160 in the background of consumer computer 164 with a sufficiently low execution priority to avoid interfering with other tasks running on the computer. The consumer can also define the time of day and percent or amount of personal computer resources allocated to the webcrawler. The consumer can also define which retailer websites and products, e.g., by specific retailer, market, or geographic region, that can be accessed by the webcrawler using the personal computer resources. Webcrawler 160 executes from consumer computer 164 and uses the consumer's login to gain access to retailer websites 152-156. Alternatively, webcrawler 160 resides permanently on consumer computer 164 and runs periodically. Webcrawler 160 identifies products available from each of retailer websites 152-156 and requests pricing and other product information for each of the identified products. Webcrawler 160 navigates and parses each page of retailer websites 152-156 to locate pricing and other product information. The parsing operation involves identifying and recording product description, UPC, price, ingredients, size, and other product information as recovered by webcrawler 160 from retailer websites 152-156. In particular, the parsing operation can identify discounted offers and special pricing from retailers 66-70. The product information from retailer websites 152-156 is sorted and stored in database 76.

Likewise, webcrawler 162 uses consumer computer 166 and login to gain access to retailer websites 152-156. Webcrawler 162 identifies products available from each of retailer websites 152-156 and requests pricing and other product information for each of the identified products. Webcrawler 162 navigates and parses each page of retailer websites 152-156 to locate pricing and other product information. The parsing operation involves identifying and recording product description, UPC, price, ingredients, size, and other product information as recovered by webcrawler 162 from retailer websites 152-156. In particular, the parsing operation can identify discounted offers and special pricing from retailers 66-70. The product information from retailer websites 152-156 is sorted and stored in database 76. The product information requests to retailer websites 152-156 can be specific to the consumer's login. Retailers 66-70 are likely to accept product information requests from webcrawlers 160-162 because the requests originate from consumer computers 164-166 by way of the consumer login to retailer websites 152-156.

Retailer service provider 72 can also collect product information from discounted offers transmitted from retailers 66-70 directly to consumers 62-64, e.g., by email or cell phone 66. Consumer 62-64 can make the personalized discounted offers and other product information available to retailer service provider 72.

Retailers 66-70 have an interest in maximizing the profit from commercial transactions with consumers 62 and 64. Profit can be expressed as unit sales of products (US) times price less cost per unit of product, as given in equation (1).

Profit=US*(price−cost) (1)

Costs are typically fixed or at least predictable in terms of inventory, raw materials, labor, facilities, equipment, taxes, and other overhead expenses. In addition, costs are similar between competing retailers with some variation for efficiency of operation and volume discounts from distributor 36. The price and demand are principal factors in determining profit. In most cases, price is inversely related to demand, as shown in price-demand curve 170 of FIG. 11. In demand curve 170 for a given product P, as price increases, unit sales decrease and, conversely, as price decreases, unit sales increase. Price elasticity of demand is a unitless measure of response in demand to changes in price, i.e., a ratio involving the percent change in demand to the percent change in price. At price point PP1, the unit sales are US1. The revenue attained by the retailer is given as PP1*US1. At price point PP2, the unit sales are US2.The revenue attained by the retailer is given as PP2*US2. If PP2 is less than PP1, then US2 is greater than US1.

In one embodiment, unit sales US can be expressed in exponential form as given in equation (2).

US(p)=Q₀*exp(−βp) (2)

where:
Q₀ is a baseline demand
β is price elasticity of demand
p is price

Profit can be optimized by determining the maximum or peak of the function where the slope is zero. The maximum of the function can be determined by substituting equation (2) into equation (1), taking the derivative of equation (1) with respect to price, and setting the function equal to zero. The profit optimization reduces to equation (3) as a relationship between price, costs, and price elasticity of demand.

price=cost+1/β (3)

Assuming cost is fixed or predictable, equation (3) relates price to the inverse of price elasticity of demand. Retailer service provider 72 can determine price for a given product and retailer directly from T-LOG data 46. Retailer service provider 72 accumulates T-LOG data 46 in database 76 from retailers 66-70 as part of the comparative shopping service provided to consumers 62-64. Alternatively, retailer service provider 72 determines price for a given product and retailer through webcrawlers 150, 160, and 162, as described in FIG. 10.

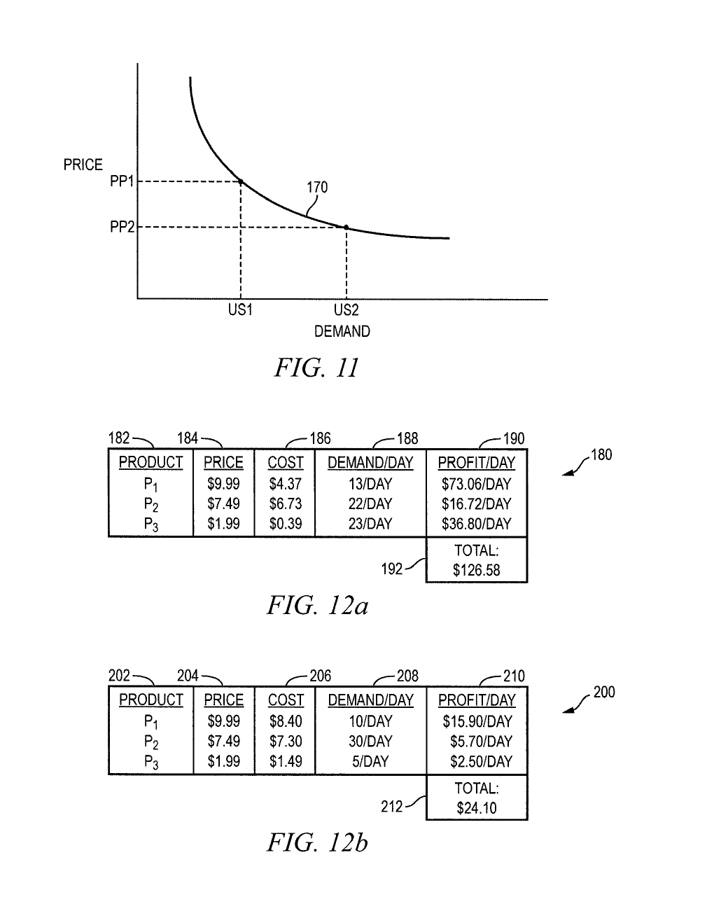

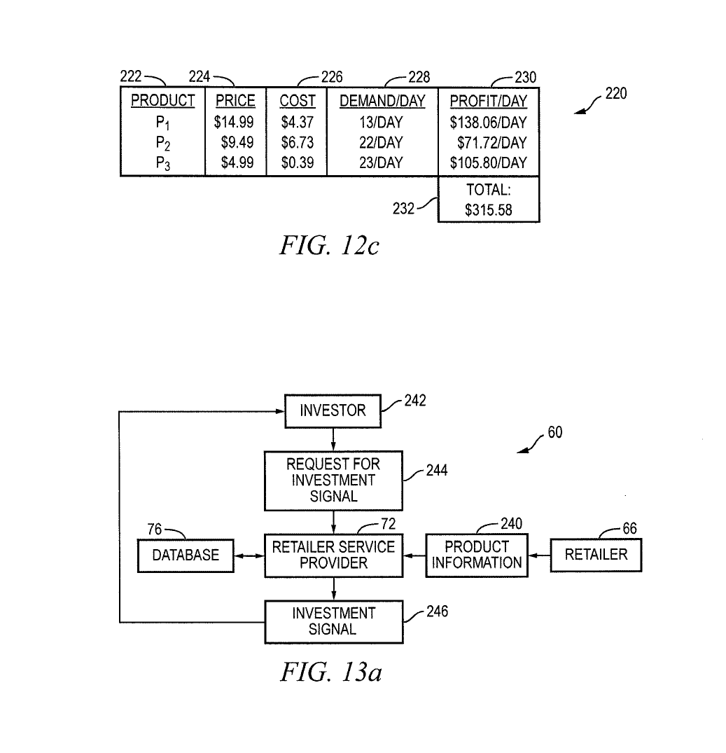

For any given retailer, retailer service provider 72 tracks information about the products sold by the retailer and stores the product information in database 76. For example, FIG. 12a shows product information for products, items, or services sold by retailer 66 in table 180. Specifically, each of the products, items, or services sold by retailer 66 are indicated in column 182.

The price for products P1-P3 is indicated in column 184. Product P1 is listed with a sales price of $9.99. The sales price of product P2 is indicated as $7.49. The sales price of product P3 is indicated as $1.99. Retailer service provider 72 learns the sales price for each product P1-P3 by one of the methods discussed above, e.g., through retailer-provided T-LOG data, webcrawlers, or reports from individual consumers utilizing the services of retailer service provider 72.

Table 180 also includes the cost for each of the products P1-P3 in column 186. Retailer service provider 72 learns the cost of each product P1-P3 to retailer 66 if retailer 66 voluntarily provides such information to retailer service provider 72. In some circumstances, retailers may be reluctant to share such detailed financial information publicly. Thus, retailer service provider can estimate the cost of each product P1-P3 based on known or approximate costs for each of the components that contribute to cost of products P1-P3 such as raw materials, labor, transportation, storage, and taxes. Retailer service provider 72 may also solicit information about the cost for products P1-P3, or similar products, from competitors of retailer 66 and infer that costs for products P1-P3 to retailer 66 are similar. Personal assistant engine 72 may also obtain information about the costs for products P1-P3 from manufacturers or suppliers of retailer 66. In the present example, retailer service provider 72 estimates the cost for each unit of product P1 to retailer 66 is $4.37. Retailer service provider 72 estimates the cost to retailer 66 for each unit of product P2 is $6.73. Retailer service provider 72 estimates the cost to retailer 66 for each unit of product P3 is $0.39.

Table 180 also includes the demand for each of the products P1-P3 in column 188. The demand is the measure of the number of products sold over a period of time. In the present example, demand is indicated as the average unit sales for each product P1-P3 each day. Table 180 indicates that retailer 66 sells an average of 13 units of product P1, 22 units of product P2, and 23 units of product P3 each day. Personal assistant engine 72 can monitor the demand for each product by analyzing T-LOG data provided voluntarily by retailers. If a retailer refuses to provide demand information voluntarily, the demand can be estimated using price elasticity of demand and price. Alternatively, demand information can be inferred from information provided by competitors selling the same or similar products.

Table 180 also indicates in column 190 the average profit per day for each product P1-P3. As discussed, profits are calculated by subtracting costs from total revenue. Thus, for example, the profit per product per day can be estimated by multiplying the demand per day by the difference between sales price and cost. In the present example, table 180 indicates in column 190 that profits per day are $73.06, $16.72, and $36.80 for products P1-P3, respectively. Accordingly, as shown in block 192, the total profits per day for retailer 66 for the sale of products P1-P3 is $126.58.

Retailer service provider 72 continues to monitor the product information for each of the products sold by retailer 66, including the sale price for each product, the estimated cost to retailer 66 for each product, the estimated or known demand or sales volume for each product, and the profits for each product. By continuing to monitor the product information from retailer 66, retailer service provider 72 can detect changes in the product information and look for investment signals to share with potential investors.

For example, FIG. 12b has table 200 which shows product information for products P1-P3 sold by retailer 66. The product information in table 200 is collected at a later date than the product information in table 180 shown in FIG. 12a. Column 202 shows each of the products P1-P3 that are sold by retailer 66, which are the same as the products sold by retailer 66 on the earlier date illustrated by table 180 in FIG. 12a. The sales price for each of the products P1-P3 remains constant, as shown in column 204. Thus, the sales price for product P1 is still $9.99, the sales price for product P2 is still $7.49, and the sales price for product P3 is still $1.99.

As shown in column 206, however, retailer service provider 72 estimates that the costs for each of the products P1-P3 to retailer 66 have increased since retailer service provider 72 collected the previous product information shown in table 180 of FIG. 12a. In particular, the cost to retailer 66 for product P1 has increased from $4.37 to $8.40. The cost to retailer 66 for product P2 has increased from $6.73 to $7.30. The cost to retailer 66 for product P3 has increased from $0.39 to $1.49. As discussed, retailer service provider 72 may know the actual costs to retailer 66 for each of the products P1-P3 because retailer 66 products such information voluntarily in the form of T-LOG data. Otherwise, retailer service provider 72 may estimate increases in cost to retailer 66 based on information provided by competitors of retailer 66 or publicly-available resources about factors that influence the cost of products P1-P3, such as the cost of raw materials, transportation, or labor. Many different factors can influence the cost for individual products. For example, the cost of labor may rise due to government-mandated wage rate increases, lack of skilled employees, or competitors entering the market and drawing away employees. Retailer service provider 72 can track and monitor such information to reach an accurate estimate for the cost to retailer 66 for each of the products sold by retailer 66.

In addition, as shown in column 208, the demand or sales volume for products P1-P3 has changed since the previous time that retailer service provider 72 collected product information. Specifically, demand for product P1 has decreased from 13 units per day to 10 units per day, demand for product P2 has increased from 22 units per day to 30 units per day, and demand for product P3 has decreased from 23 units per day to 5 units per day. Again, the sales volume or demand for each of the products P1-P3 can be known by retailer service provider 72 voluntarily sharing such product information with retailer service provider 72 in the form of T-LOG data. Alternatively, retailer service provider 72 can estimate the volume of products sold based on the sales price of the products and the price elasticity of demand. In another embodiment, retailer service provider 72 collects information from consumers who use retailer service provider 72 to assist in planning shopping trips, and estimates the sales volume or demand based on the representative sample of consumers using the services of retailer service provider 72. Like the cost of products, the demand for products can vary due to many different reasons. For example, competitors may enter the market offering the same or similar product for a lower price, a higher quality, or at a more convenient location. In addition, substitute products may be introduced into the market that consumers choose to purchase instead of the products sold by retailer 66. Otherwise, a particular product may simply become more or less popular among consumers due to trends, marketing, or other cultural reasons.

The increased costs and the changes in demand for products P1-P3 each impact the profits to retailer 66, as shown in column 210 of table 200. Specifically, because of increased costs and decreased demand for product P1 the profit per day for product P1 decreased from $73.06 per day to $15.90 per day. In the case of product P2, although the demand increased slightly, the increase in cost caused profits to decrease from $16.72 per day to $5.70 per day. With respect to product P3, the increased cost and decreased demand caused profits to decrease from $36.80 per day to $2.50 per day. Thus, the total profits as indicated in block 212 of table 200 decreased from $126.58 to $24.10.

In another scenario illustrated by FIG. 12c, retailer 66 increases profits for products in order to boost short-term profits. Table 220 illustrates the product information for products sold by retailer 66 shortly after retailer service provider 72 collected the product information shown in FIG. 12a. Column 222 illustrates retailer 66 continues to stock products P1-P3. As shown, in column 224, however, retailer 66 raises the sales prices for each of the products P1-P3. Specifically, retailer 66 raises the sales prices for product P1 from $9.99 to $14.99, product P2 from $7.49 to $9.99, and product P3 from $1.99 to $4.99. The costs and demand for products P1-P3, however, remain the same as in table 180 of FIG. 12a as shown in columns 226 and 228, respectively. Thus, retailer 66 sees a dramatic increase in profits. Specifically, the profits for product P1 increase from $73.06 per day to $138.06 per day. The profits for product P2 increase from $16.72 per day to $71.72 per day. The profits for product P3 increase from $36.80 per day to $105.80 per day. Thus, the total profits per day increase from $126.58 per day to $315.58 per day, as shown in block 232.

Under any of the scenarios illustrated by FIGS. 12a-12c, the product information shown in tables 180, 200, and 210 is useful to investors interested in deciding whether to invest in retailer 66. In particular, investors have an interest in acting, as soon as possible, when changes occur that impact the financial health of retailer 66. Changes with respect to the price, cost, or demand for products sold by retailer 66 will directly impact the profit of retailer 66, and by extension, the risk to an investor of investing in retailer 66. Retailer service provider 72, therefore can collect and compile product information from retailers in the commerce system for the purposes of detecting changes or patterns, i.e., investment signals with respect to the financial well-being of retailers.

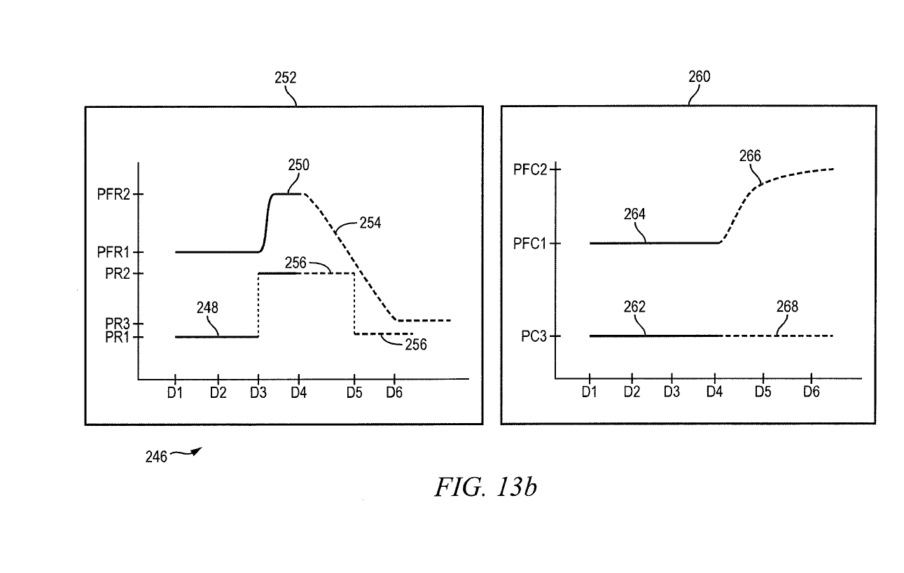

An investor considering whether to invest in a particular company values investment signals that help the investor determine whether the investment will result in a positive return. For example, FIG. 13a illustrates commerce system 60, with retailer service provider 72 collecting product information 240 from retailer 66 and storing the product information 240 in database 76.

Investor 242, meanwhile, is considering acquiring retailer 66. During negotiations, retailer 66 shows investor 242 data reflecting increased profits consistent with the increase in daily profits shown in FIG. 12c. Investor 242, however, wishes to verify the trend in increased profits is accurate and reflects a likelihood that profits will remain high before acquiring or investing in retailer 66. Investor 242 is in electronic communication with retailer service provider 72 and sends a request for an investment signal 244 to retailer service provider 72, asking for information about the financial stability of retailer 66. Investor 242 may participate in a bidding process with other investors for exclusive access to the investment signal, or may simply pay a fee or a percentage of a future investment transaction in exchange for retailer service provider 72 providing access to the investment signal. After analyzing the product information 240 from retailer 66, retailer service provider 72 provides investment signal 246 to investor 242. Investor 242 can utilize the investment signal 246 to make decisions about when, whether, and how much to invest in retailer 66.

FIG. 13b illustrates further detail of investment signal 246. In the present example, investment signal 246 takes the form of an analysis of the price curve 248 for products sold by retailer 66 over time with respect to profit curve 250. Specifically, investment signal 246 indicates in chart 252 that products at retailer 66 are sold for price PR1 on dates D1-D3, but after date D3, retailer 66 increases prices for products to price PR2, with price PR2 being greater than price PR1.

Consistent with the stable price curve 248 between dates D1-D3, investment signal 246 indicates a stable profit curve 250 between dates D1-D3 with profit PFR1. When retailer 66 increases prices for products from price PR1 to price PR2, profit curve 250 has a corresponding increase from PFR1 to PFR2, with PFR2 being greater than PFR1 for a short period of time between dates D3 and D4. Date D4 is the date that investor 242 approaches retailer service provider 72 requesting investment signal 246.

Retailer 66 experiences short-term increases in profits, as indicated by profit curve 250 between dates D1-D4. Retailer service provider 72, however, forecasts the future profit curve 254 for retailer 66 will decline due to the increased prices after date D4, based on future price curve 256 of products sold by retailer 66, and the cost and demand for products as calculated by retailer service provider 72. In addition, even if retailer 66 lowers prices for products back to price PR1 on date D5, retailer service provider 72 forecasts the profit curve 254 will continue to decline until settling at profit PFR3 on date D6, with profit PFR3 being less than profit PFR1 and PFR2. Thus, retailer service provider 72 detects the change in prices for products sold by retailer 66 and forecasts a decline in medium- and long-term profits, despite a short-term increase in profits.

Investment signal 246 also includes chart 260 analyzing the prices of products sold by retailer 68, a direct competitor of retailer 66, and the corresponding profits over the same period of time. Specifically, the price curve 262 for products sold by retailer 68, which are the same as or similar to products sold by retailer 66, indicates a stable price PC3 between dates D1 and D4. Consistent with the stable price curve 262 between dates D1 and D4, investment signal 246 indicates a stable profit curve 264 between dates D1-D4 with profit PFC1. When retailer 66 increases prices for products on date D3 from price PR1 to price PR2, profit curve 264 for retailer 68 remains stable at profit PFC1 because consumers shopping at retailer 66 have not yet reacted to the increased prices. Retailer service provider 72, however, provides forecasted profit curve 266, which is a forecast for profits to retailer 68 following date D4. Retailer service provider 72 recognizes that retailer 68 sells products that are the same or similar to products sold by retailer 66 and that retailer 68 is in the same geographical area as retailer 66. Thus, retailer service provider 72 is able to forecast that if retailer 68 keeps prices stable as indicated by price curve 268 following date D4, the profits for retailer 68 will increase from profit PFC1 to profit PFC2 as indicated by profit curve 266 due to consumers choosing to shop at retailer 68 rather than retailer 66.

Accordingly, by analyzing the product information from retailers 66 and 68, retailer service provider 72 is able to detect trends and provide an investment signal 246 to investor 242 to assist investor 242 in making investing decisions in the commerce system. Specifically, retailer service provider 72 is capable of detecting whether a particular retailer is manipulating pricing data for the purposes of disguising the true value of the company, whether prices are increasing consistently across a given market, or whether changes in price are due to specific changes in cost to the retailer. By monitoring product information, including prices, cost, demand, and profits, for a plurality of retailers engaging in economic activity within the commerce system, retailer service provider 72 is able to identify investment signals and alert investors of the existence and value of the investment signals.

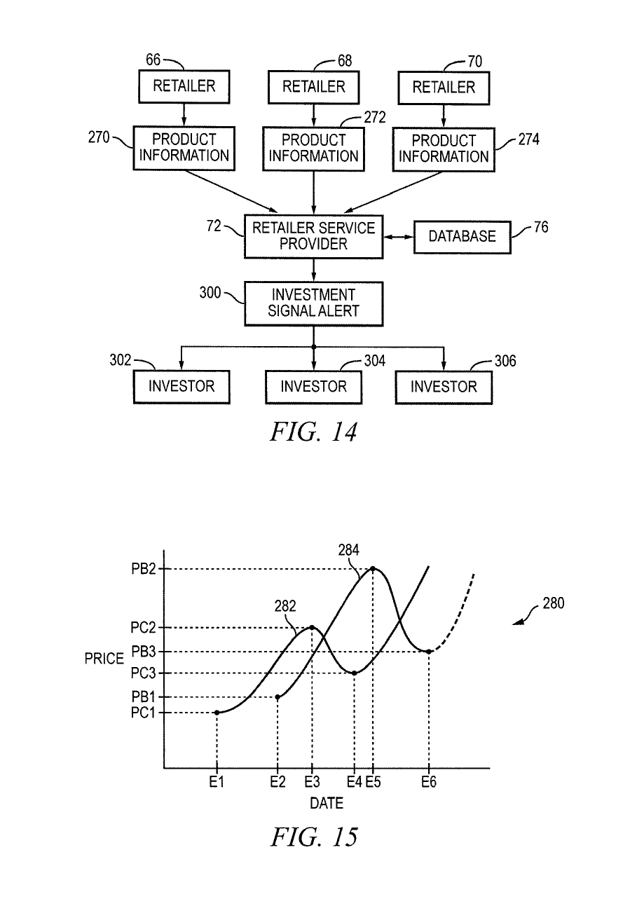

FIG. 14 illustrates commerce system 60 from FIG. 3 with retailer service provider collecting product information 270, 272, and 274 from retailers 66, 68, and 70, respectively. As discussed, product information about the products sold by retailers 66, 68, and 70, can be provided voluntarily in the form of T-LOG data, or collected and estimated by other methods. Product information 270, 272, and 274 is stored in database 76 and updated regularly to reflect changes such as increases in sales price, cost, demand, or profit. Product information 270, 272, and 274 may also include a record of individual transactions that occur at retailers 66, 68, and 70.

As retailer service provider 72 collects product information 270, 272, and 274, retailer service provider 72 automatically analyzes the product information to look for trends and potential investment signals. As discussed, investment signals include factors that may impact the value of a particular investment, or may enable investors to forecast the future value of a particular investment, such as changes in price, cost, demand, or profit for individual products. Investment signals also include changes in the financial outlook for individual retail outlets or across a chain of retailer outlets, such as forecasts for future profits or the value of shares of equity in the retailer or company.

In addition, the product information collected by retailer service provider 72 enables retailer service provider 72 to detect patterns and forecast financial outcomes with respect to local, national, and international economies as a whole. For example, inflation is a measure of the percentage rise in the general level of prices of goods and services in an economy over a period of time. As prices increase, the purchasing power of money decreases, since fewer products or services can be purchased for the same amount of money.

The inflation rate is traditionally measured by measuring changes to a price index for goods and services. One popular price index for measuring inflation is the consumer price index (CPI). The CPI is a measurement, calculated by a government institution, of changes in prices for a representative sample of products or services exchanged in the national economy. The representative products are frequently described as a “market basket” of goods and services that are commonly purchased by consumers in the commerce system. Prices for the “market basket” of goods and services are collected periodically (e.g., on a monthly basis) from a representative sample of merchants. Thus, the CPI, although it is a commonly used method for measuring inflation, does not consider the actual changes in prices across every retailer, manufacturer, and supplier for every product or service in the commerce system. Instead, inflation is estimated based on the prices for a sample subset of goods and services collected at periodic and infrequent intervals.

Inflation is an important indicator for the health of the economy as a whole, but inflation is also an important data point for determining the value of certain types of investments. For example, a bond is a negotiable certificate that certifies a borrower (the bond issuer) is indebted to a lender (the bond holder) for a specific amount of money, and that the borrower must pay back the lender for the principal loan amount plus interest. Private companies and governments regularly issue bonds (i.e., borrow money) for the purposes of obtaining capital. Typically, private corporate bonds take the form of a formal contract to repay borrowed money with interest at fixed intervals, such as monthly, semi-annually, or annually. Because bonds are typically negotiable instruments, and can be transferred to third parties in a secondary market, bonds are a popular investment tool. The risk associated with investing in traditional bonds, however, is directly impacted by changes in inflation, since the interest rate is typically fixed and not tied to inflation. Thus, when inflation increases, because the interest rate for the bond does not also increase, the relative value of the bond decreases.

Accordingly, investors participating in the secondary market for trading bonds value accurate information about inflation. Unfortunately, traditional estimates of inflation (e.g., the CPI) take into account a limited sample of products determined to be representative of the overall economy, and do not measure prices for all, or even the majority, of goods and services exchanged in the commerce system. Furthermore, traditional methods for measuring inflation involve only collecting data and calculating inflation periodically, for example, once per month.

Meanwhile, retailer service provider 72 collects product information, including sales prices, from a much larger set of retailers, manufacturers, and suppliers participating in the national commerce system. Retailer service provider 72 also collects product information for a much larger sample of goods and services exchanged in the commerce system. At the same time, retailer service provider 72 collects the product information much more regularly (e.g., multiple times per day, daily, or weekly), and is capable of providing an accurate and real-time measurement of inflation, as prices change within the commerce system. Retailer service provider 72 can therefore track inflation as an investment signal to provide to investors in the commerce system.

In another example, FIG. 15 illustrates retailer service provider detecting investment signal 280 based on product information from retailers in the commerce system. Specifically, investment signal 280 illustrates the changes in price for a first product represented by price curve 282 and changes in price for a second product represented by price curve 284. Price curve 282 for the first product is a leading indicator for price curve 284 for the second product. A leading indicator is a trend or change in data that occurs before another trend or change in data.

For example, assume price curve 282 reflects the average price for corn in the national economy and price curve 284 reflects the average price for beef in the national economy. On date E1, the price of corn as illustrated by price curve 282 is PC1, but after date E1, begins rising toward price PC2, with price PC2 greater than price PC1. In response to the rise in price for corn, the price of beef as represented by price curve 284 begins to rise on date E2 from price PB1 toward price PB2, with price PB2 greater than price PB1. The rise in price for beef lags behind the rise in price for corn, which is used to feed cattle. Similarly, after date E3, when the price for corn peaks at price PC2, the price for corn declines until reaching price PC3 on date E4, with price PC3 being less than price PC2. In response to the decline in price for corn, the price for beef as represented by price curve 284 begins to decline after date E5 from price PB2 toward price PB3. Meanwhile, after date E4, the price for corn begins to increase again.

Retailer service provider 72 identifies investment signal 280, including the fact that the price curve 282 for the price of corn is a leading indicator for price curve 284 for the price of beef. Once retailer service provider 72 identifies the investment signal 280, retailer service provider 72 can forecast an increase in the price for beef on date E6 following the increase in the price of corn on date E4, and notify potential investors in the beef industry of the discovery of the investment signal.

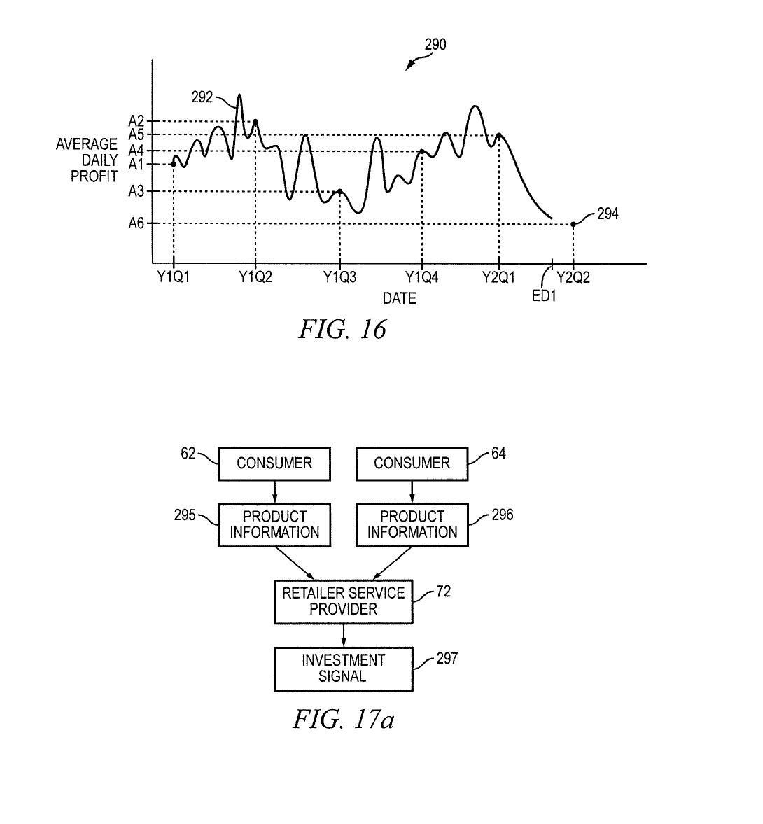

In another scenario illustrated by FIG. 16, retailer service provider 72 detects investment signal 290 by analyzing daily profits for retailer 70 in relation to quarterly earnings reports provided by retailer 70. On date Y1Q1, retailer 70 releases a quarterly earnings report as obligated under regulations for publicly traded companies. The earnings report released by retailer 70 on date Y1Q1 indicates an average daily profit during the previous three-month period of amount A1. On date Y1Q2, retailer 70 releases a second quarterly earnings report indicating average daily profits between dates Y1Q1 and Y1Q2 of amount A2, with amount A2 being greater than amount A1. On date Y1Q3, retailer 70 releases a third quarterly earnings report indicating average daily profits between dates Y1Q2 and Y1Q3 of amount A3, with amount A3 being less than amounts A1 and A2. On date Y1Q4, retailer 70 releases a fourth quarterly earnings report indicating average daily profits between dates Y1Q3 and Y1Q4 of amount A4, with amount A4 being less than amount A2 and more than amount A1. On date Y2Q1,retailer 70 releases a fifth quarterly earnings report indicating average daily profits between dates Y1Q4 and Y2Q1 of amount A5, with amount A5 being greater than amount A4 but less than amount A2.

Meanwhile, over the same period of time between dates Y1Q1 and Y2Q1, retailer service provider 72 tracks prices for the products sold by retailer 70. Retailer service provider 72 also tracks known or estimated costs, demand, and profits for the product sold by retailer 70. Thus, retailer service provider 72 is able to produce average daily profits curve 292, which tracks the average daily profits of retailer 72 on a daily basis (as opposed to a quarterly basis), similar to the data shown in FIGS. 12a-12c.

Retailer 70 is scheduled to release the next quarterly earnings report on date Y2Q2. In response to profits indicated in the earnings report, investors in the commerce system will choose to buy or sell shares of stock for retailer 70. The earnings report on date Y2Q1 indicated an average daily profit for retailer 70 of amount A5, which was greater than the average daily profit indicated by the earnings report on date Y1Q4 of amount A4. Retailer service provider 72, however, detects the average daily profits following the earnings report on Y2Q1 have declined sharply as shown by average daily profits curve 292 following date Y2Q1. Therefore, prior to date Y2Q2, on earlier date ED1, retailer service provider 72 is able to provide a forecasted value 294 of amount A6 for the average daily profit that will be indicated by the earnings report on date Y2Q2. Thus, retailer service provider 72 has detected an investment signal 290 that potential investors will be anxious to know, so that the investors can act quickly to buy or sell shares of stock in retailer 70 prior to the release of the earnings report on date Y2Q2. Investors who have access to investment signal 290 will be able to act sooner to buy or sell shares of stock in retailer 70 than investors who have to wait until the next earnings report is produced on date Y2Q2.

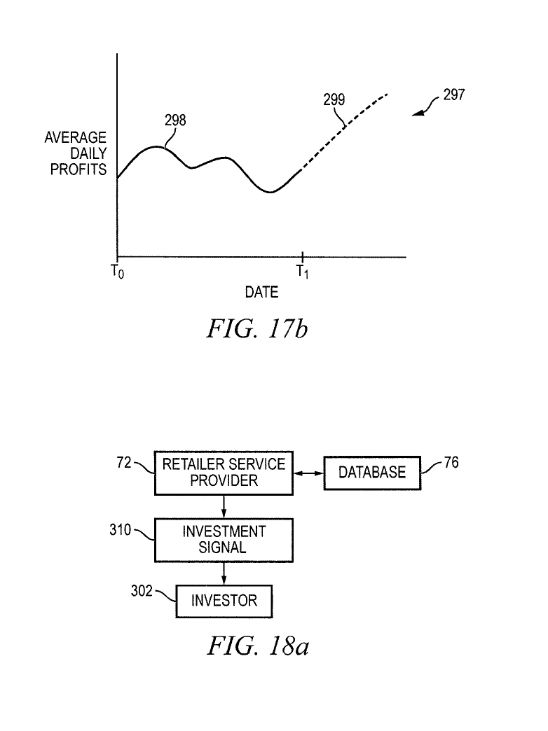

FIG. 17a illustrates another embodiment in which retailer service provider 72 collects product information from an entity or actor in the commerce system other than a retailer or a merchant. In the present example, retailer service provider 72 collects product information 295 and 296 from consumers 62 and 64, respectively, instead of retailers or merchants, and generates an investment signal 297 based on the product information. The product information collected from consumers 62 and 64 takes the form of data regarding the consumers' preferences for particular product attributes, as shown in FIG. 8, or the consumers' intent to purchase a particular type of product. For example, retailer service provider 72 collects intent-to-purchase data from consumers 62 and 64, who indicate to retailer service provider 72 an intention to purchase brand A bread. Retailer service provider 72 collects the same intent-to-purchase data as product information from a number of other consumers in the commerce system, and is able to generate or detect investment signal 297.

FIG. 17b shows further details of investment signal 297, with profit curve 298 showing the average daily profits over time from date T0 to date T1 as measured or calculated by retailer service provider 72 using methods discussed above. Dates after T1 have not yet occurred, but retailer service provider 72 is able to generate a forecasted profit curve 299 after date T1, based on the product information 295 and 296 collected from consumers 62 and 64, and other consumers in the commerce system. Specifically, retailer service provider 72 knows that consumers in the commerce system intend to purchase brand A bread, and can therefore provide a projected or forecasted profit curve 299 for the future profitability of brand A bread and provide the forecasted profitability curve 299 to investors as an investment signal. In the present example, retailer service provider 72 detects that demand for brand A bread is increasing because of the number of consumers indicating an intent to purchase brand A bread. Thus, retailer service provider 72 projects increased profitability for brand A as shown by forecasted profit curve 299.

In other scenarios, consumers may simply indicate a desire to purchase particular products with particular preferences for particular product attributes as shown in FIG. 8. An investor or a retailer may approach retailer service provider 72 to seek information about the profitability of releasing a new product to the marketplace. Because retailer service provider 72 collects data from consumers about consumer preferences for products, including the price consumers are willing to pay for products, retailer service provider 72 can estimate demand for a new product or product line and provide the estimated demand to investors or retailers as an investment signal regarding the new product or product line. Retailer service provider 72 can utilize product information collected from consumers about preferences for particular product attributes, or prices consumers are willing to pay, to forecast demand for products, including products that have not been released.

Thus, retailer service provider 72 does not merely collect product information from retailers, manufacturers, or merchants to generate or detect an investment signal. Instead, retailer service provider 72 collects product information from a variety of entities operating in the commerce system, including consumers. Product information includes data about products that are bought and sold in the commerce system, or intent-to-purchase data collected from consumers. Product information also includes prices consumers are willing to pay for products, preferences for particular product attributes, or demand for products. Retailer service provider 72 uses the product information collected from actors in the commerce system to generate a variety of investments signals relevant to investors, such as profitability of companies, or marketability of products.

Returning to FIG. 14, when retailer service provider 72 identifies an investment signal indicating a trend that may be relevant to potential investors, retailer service provider 72 sends an investment signal alert 300 to investors 302, 304, and 306, who are in electronic communication with retailer service provider 72. Investment signal alert 300 can be an electronic mail (email) message, or a notification or alert posted to a website accessible from computer systems owned and operated by investors 302, 304, and 306. Investment signal alert 300 is a notification that is automatically sent to investors 302, 304, and 306 that retailer service provider 72 has identified an investment signal that may be of interest to investors 302, 304, and 306. Investment signal alert 300 describes or names the particular retailer or entity to which the investment signal relates, and may describe the nature of the investment signal without giving away specific details of the investment signal. Investment signal alert 300 also includes a value or price for access to the data of the investment signal. For example, retailer service provider 72 may request a specific price for access to the investment signal, or may request a percentage of the value of shares of stock that are traded in response to the investment signal.

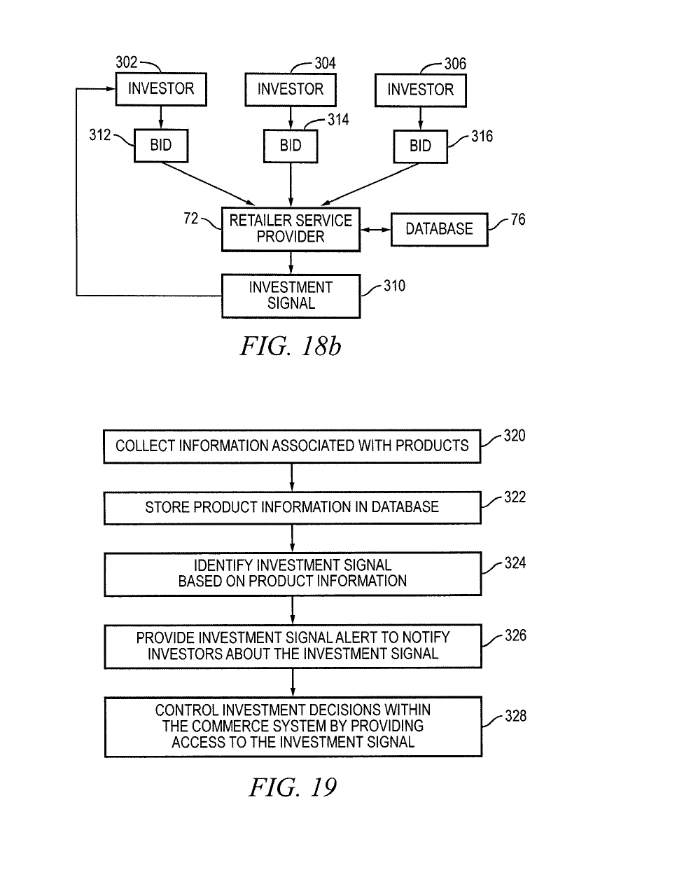

FIG. 18a illustrates retailer service provider 72 providing investment signal 310 to investor 302, after investor 302 agrees to pay retailer service provider 72 the price requested. Retailer service provider 72 may provide access to investment signal 310 to multiple investors, or may provide exclusive access to investment signal 310 to a single investor. Access to an investment signal may be provided in the form of a graphical display of the investment signal, such as a chart, graph, or table, as shown in FIGS. 12a-12c, 13b, 15, 16, and 17b on a website maintained by retailer service provider 72. Alternatively, retailer service provider 72 may provide access to an investment signal through a graphical display of a software application running on a computer system owned and operated by the investor and in electronic communication with electronic communication network 80. Retailer service provider 72 may also provide access to the investment signal through other electronic means, such as email, or by providing a hard copy of the investment signal data.

In another embodiment, illustrated in FIG. 18b, retailer service provider 72 provides a website interface for investors 302, 304, and 306 to submit bids 312, 314, and 316, respectively, to retailer service provider 72 for exclusive access to investment signal 310. Thus, investors 302, 304, and 306 can engage in an auction for the right to exclusive access to investment signal 310. Retailer service provider 72 selects one of the investors 302, 304, or 306, based on the price that the investors are willing to pay, who will receive access to investment signal 310. For example, retailer service provider 72 may allow investors 302, 304, and 306 to bid a flat fee for access to investment signal 310, and retailer service provider 72 selects the investor willing to pay the highest flat fee. Alternatively, retailer service provider 72 may allow investors 302, 304, and 306 to bid to pay retailer service provider 72 a percentage or portion of an investment purchase, such as a percentage of a stock trade. Retailer service provider 72 provides access to investment signal 310 to the investor willing to pay the highest price. In the present example, retailer service provider 72 provides access to investment signal 210 to investor 302 because investor 302 offered to pay the highest amount in exchange for access to investment signal 210.

FIG. 19 illustrates a process for controlling a commerce system by enabling investors to gain access to an investment signal. In step 320, product information is collected associated with a plurality of products. The product information can be receiving the product information from a retailer in the form of transactional data, retrieved from a retailer website, or provided by consumers who purchase products from the retailer. In step 322, the product information is stored in a database. In step 324, an investment signal is identified based on the product information. The investment signal may include changes in forecasted profits, the value of a share of a stock, or changes in price, cost, or demand for products. In step 326, an investment signal alert is provided to notify investors about the investment signal. In step 328, investing decisions within the commerce system are controlled by enabling the first consumer to select products for purchase based on the shopping list including the selected products of interest.

While one or more embodiments of the present invention have been illustrated in detail, the skilled artisan will appreciate that modifications and adaptations to those embodiments may be made without departing from the scope of the present invention as set forth in the following claims.

What is claimed:

1. A method of controlling a commerce system, comprising:
collecting product information associated with a plurality of products;
storing the product information in a database;
identifying an investment signal based on the product information;
providing an investment signal alert to notify investors about the investment signal; and
controlling investment decisions within the commerce system by providing access to the investment signal.

2. The method of claim 1, wherein the product information includes a sale price for the products, an estimated cost to a retailer for the products, and an estimated demand for the products.

3. The method of claim 1, wherein the investment signal includes a forecasted future value for investing in a retailer based on the product information.

4. The method of claim 1, wherein the investment signal includes an estimated future profitability of a retailer based on the product information.

5. The method of claim 1, further including accepting a bid for access to the investment signal.

6. The method of claim 5, wherein the bid includes an offer to share a portion of an investment trade.

7. A method of controlling a commerce system, comprising:
collecting product information associated with a plurality of products;
storing the product information in a database;
identifying an investment signal based on the product information; and
providing access to the investment signal.

8. The method of claim 7, further including providing an investment signal alert to notify investors about the investment signal.

9. The method of claim 7, wherein the product information includes a sale price for the products, an estimated cost to a retailer for the products, and an estimated demand for the products.

10. The method of claim 7, wherein the investment signal includes a forecasted future value for investing in a retailer based on the product information.

11. The method of claim 7, wherein the investment signal includes an estimated future profitability of a retailer based on the product information.

12. The method of claim 7, further including accepting a bid for access to the investment signal.

13. The method of claim 7, wherein the product information includes intent-to-purchase data.

14. A method of controlling a commerce system, comprising:
collecting product information associated with a plurality of products;
identifying an investment signal based on the product information; and
providing access to the investment signal.

15. The method of claim 14, wherein the investment signal includes an estimated future profitability of a retailer based on the product information.

16. The method of claim 14, further including providing an investment signal alert to notify investors about the investment signal.

17. The method of claim 14, wherein the product information includes a sale price for the products, an estimated cost to a retailer for the products, and an estimated demand for the products.

18. The method of claim 14, wherein the investment signal includes a forecasted future value for investing in a retailer based on the product information.

19. The method of claim 14, further including accepting a bid for access to the investment signal.

20. The method of claim 14, wherein the product information includes intent-to-purchase data.

21. A computer program product usable with a programmable computer processor having a computer readable program code embodied in a non-transitory computer usable medium for controlling a commerce system, comprising:
collecting product information associated with a plurality of products;
identifying an investment signal based on the product information; and
providing access to the investment signal.

22. The computer program product of claim 21, further including providing an investment signal alert to notify investors about the investment signal.

23. The computer program product of claim 21, wherein the product information includes a sale price for the products, an estimated cost to a retailer for the products, and an estimated demand for the products.

24. The computer program product of claim 21, wherein the investment signal includes a forecasted future value for investing in a retailer based on the product information.

25. The computer program product of claim 21, further including accepting a bid for access to the investment signal.
